(19) United States
(12) Patent Application Publication
(10) Pub. No.: US 2004/0261316 A1
(43) Pub. Date: Dec. 30, 2004

(54) Pressurized coal gasification fuel distribution, feed, and burner system

(76) Inventor: Lloyd E. Weaver, Harpswell, ME (US)

Correspondence Address: Bourque & Associates, P.A., Suite 301, 835 Hanover Street, Manchester, NH, 03104, US

(21) Appl. No.: 10/827,906

(22) Filed: Apr. 20, 2004

Related U.S. Application Data
(63) Continuation-in-part of application No. 10/293,815, filed on Nov. 12, 2002.
(60) Provisional application No. 60/464,037, filed on Apr. 21, 2003.

(51) Int. Cl. C10J 3/68; C10J 1/00; F27B 5/00

(52) U.S. Cl. 48/210; 48/77; 48/101; 48/111; 48/209; 48/197 FM

(57) ABSTRACT

A PCPG (Pulverized Coal Pressurized Gasifier) including improved fuel distribution means among burners, better burner feeding, enhanced flame retention burner, and improved process control. The flame retention burner has a both a rapidly spinning air flow to create a tornado effect plus a Coanda effect from the swirled air causing traverse eddies into the burning air/fuel mixture and induced circulation eddies of hot gas to prolong exposure of coal particles to hot flame conditions near the ignition area to achieve increased multiple chances to mate air with coal particles. This burner coupled to individualized fuel feed and precise measurements and controls and two-stage PCPG entrained flow and ash bed reactor spaces minimizes carbon in the ash and maximizes gas-making efficiency.

### CROSS-REFERENCE TO RELATED APPLICATIONS

This application claims the benefit of U.S. Provisional Application No. 60/464,037, filed Apr. 21, 2003 and is a continuation-in-part of U.S. application Ser. No. 10/293,815, filed Nov. 12, 2002.

### TECHNICAL FIELD

The present invention relates to gasifiers and more particularly, relates to a method and apparatus for improved combustion within a gasifier.

### BACKGROUND INFORMATION

Pressurized coal gasification processes have been typically either fluidized bed or transport reactor types that which generally combine pulverized coal, pure oxygen, and steam to create the gasification. These known gasification processes suffer from several problems. One problem is that the use of pure oxygen greatly increases the capital and operating costs. Since there are no known sources of pure oxygen, the pure oxygen must be produced. Unfortunately, the production of pure oxygen is complex and requires an expensive manufacturing facility that utilizes a great deal of energy. As a result, the overall energy producing efficiency of the known pure oxygen gasification processes are greatly reduced since a significant amount of the energy produced by the gasification processes is used up or wasted in the production of the pure oxygen for the gasification process. This ability for this invention to work with air, however, doesn't preclude the use of pure oxygen in this invention substituted for air which has certain advantages to the petrochemical industry for making chemicals and liquid fuels.

Additionally, the operating temperature of present pure oxygen gasification processes is significantly higher due to slagging designs for ash removal, this invention removes the as in granular form. This leads to increased capital costs because the equipment must be capable of withstanding prolonged exposure to the elevated temperatures. Moreover, the equipment must be serviced more often, thus increasing the amount of downtime and labor costs, further adding to the overall cost of the process.

Another method of gasification uses pressurized air and lower temperature reactions. This process is explained in greater detail in U.S. patent application Ser. No. 10/293,815 (hereinafter referred to as the '815 patent application), filed Nov. 12, 2002, which is fully incorporated herein. This pressurized air gasification process is typically a pressurized gas producer, and is generally categorized as a low temperature gasifier process. Gas is formed from heat of combustion of coal with steam, when combusting at near theoretical air/fuel mixtures associated with gasification at lower temperatures (1650 F range). The usual final combustible gases resulting from the reactions are carbon monoxide (CO), hydrogen (H2), and heat.

The advantage of pressurized combustion-gasification processes is much smaller vessels and the ability to work with efficient integrated gasification combined cycle (IGCC) power systems and the ability to nearly eliminate sulfur pollution by sulfur reactions at the lower temperatures by adding limestone or dolomite with the combusted fuel. The lime or dolomite reacts with sulfur in the coal to form calcium sulfate, which is removed in the ash and hot gas filter downstream of the gasifier. This reaction between lime and sulfur, for example, is well known at the temperature of operation of this gasifier invention. With thorough, reliable gasification that the well controlled multiple burners of this invention make possible and low parasitic losses, up to 50% power efficiency is possible with IGCC. Reaction temperature may be higher or lower depending on the coal characteristics such as Btu, ash, and moisture content.

The burner arrangement described in the '815 patent application is generic in nature, and relied on a single randomized chamber to distribute fuel evenly to burners. It also relied on inputs of burner experts in the field to finalize a burner solution. Burners in the '815 patent application were sidewall mounted on the gasifier. As will be described in greater detail hereinbelow, one aspect of the present invention is that the burners are top mounted down-flow vertical burners, better taking advantage of gravity and bulk fuel storage to distribute the fuel uniformly between multiple burners. This arrangement is most compatible with the necessary fuel distribution and feed arrangement and requirements. Although a vertical top mounted burner orientation is preferred and is shown in the present invention, the present invention's same fuel distribution and feed arrangement could just as well be applied to horizontal sidewall mounted burners.

Thus, what is needed is a method and apparatus for improving the fuel distribution to each burner. The method and apparatus should also preferably improve the sensing and control (air, steam and fuel flow rates, gasification temperature, gas CO₂ and CO content) of feed to individual burners as well as improve the burners themselves. The improved burner preferably should lengthen the time coal is exposed to the high temperature region near the burner nozzle using an improving flame retention burner by adding the Coanda effect to a flame retention burner air swirl or tornado effect of rapidly spiraling air around the entering fuel mass. Charging fuel to the gasifier under pressure is preferably not changed from the '815 patent application gasifier patent application. That is, it uses large pressurized and nitrogen purged silos alternatively filled and emptied several times a day through large valves. These silos are used in pairs; one filling while one is emptying. Valves with long life cycles would also enable such tanks or silos to be small enough to sit atop the gasifier to further take advantage of gravity. Thus three such silos are used to achieve maximum feed reliability to burners.

It is important to note that the present invention is not limited to satisfying one or more of the above features or advantages of the invention. It is also important to note that modifications and substitutions by one of ordinary skill in the art are considered to be within the scope of the present invention, which is not to be limited except by the following claims.

### SUMMARY

The present invention features a burner system, according to one embodiment of the present invention, which includes a gasifier chamber, a fuel chamber, and at least one burner. The fuel chamber is disposed above the gasifier and is adapted to contain a quantity of substantially dry pulverized coal. In the preferred embodiment, fuel chamber is removably secured to the gasifier chamber and includes at least one burner. The burner is disposed about a top region of the gasifier chamber and is adapted to flow the substantially dry pulverized coal from the fuel chamber into the gasifier chamber.

According to the preferred embodiment, the burner includes a first and a second passageway. The first passageway is adapted to flow the substantially dry pulverized coal from the fuel chamber into the gasifier.

The second passageway is adapted to flow a quantity of pressurized air and/or steam from an air source and steam source, respectively, into the gasifier chamber. The second passageway is preferably sized and shaped to promote a substantially helical airflow pattern as the pressurized air and steam enters the gasifier chamber. The pressurized air and steam preferably exit the second passageway substantially adjacent to and preferably substantially encompasses the first passageway. A Coanda effect is preferably generated by pressurized air and steam as it enters the gasification chamber around the nose of the fuel nozzle.

Another embodiment of the present invention includes an apparatus for gasifying pulverized coal. The apparatus includes a device for injecting substantially dry pulverized coal fuel mix into a gasifier chamber proximate a top region of the gasifier chamber, a device for injecting steam into the gasifier chamber, a device for injecting pressurized air or oxygen into the gasifier chamber, and a device for generating a Coanda effect within the gasifier chamber.

According to a further embodiment of the present invention, the present invention includes a method of increasing burn dwell time within a gasifier. The method includes the acts of injecting pulverized coal (preferably substantially dry pulverized coal, with elements mixed in to reduce pollution effects form burning coal, such as pulverized limestone) into a gasifier chamber proximate a top region of the gasifier chamber and injecting steam into the gasifier chamber. Air, pure oxygen, or some mixture thereof, is injected into the gasifier chamber proximate the top region of the gasifier chamber. The pulverized coal, oxygen and steam are then mixed within the gasifier and the resulting mixture is gasified within the gasifier to generate a gas and bi-products. A substantially helical airflow pattern is also preferably created as the pressurized air and steam enters the gasifier chamber.

A Coanda effect is preferably generated within the gasifier chamber by the pressurized air and steam flowing around the curved tip of the fuel nozzle. To facilitate fuel flow, steam and pressurized air are optionally combined with the substantially dry pulverized coal immediately prior to injecting the substantially dry pulverized coal into the gasifier chamber in addition to injecting steam and pressurized air directly into the gasifier chamber.

According to yet another embodiment of the present invention, a method of gasifying pulverized coal includes the acts of injecting substantially dry pulverized coal into a gasifier chamber using a plurality of burners disposed proximate a top region of the gasifier chamber. To facilitate fuel flow, steam and pressurized air are optionally mixed with the substantially dry pulverized coal immediately prior to injecting the substantially dry pulverized coal into the gasifier chamber.

A Coanda effect is preferably generated within the gasifier chamber by the steam and pressurized air, thus aiding in the mixture and combustion with the gasifier chamber. The mixed pulverized coal, oxygen and steam is then gasified within the gasifier to generate a gas and bi-products.

### BRIEF DESCRIPTION OF THE DRAWINGS

These and other features and advantages of the present invention will be better understood by reading the following detailed description, taken together with the drawings wherein:

FIG. 1 is a sectional view of the gasifier showing fuel distribution and burner combination in conjunction with the upper bell cover and cylindrical walls of the gasifier; and

FIG. 2 is an exploded perspective view of the Coanda effects and swirl design on fuel and airflow near the ignition zone of the burner nozzle.

### DETAILED DESCRIPTION OF THE PREFERRED EMBODIMENTS

This description enables one skilled in the art of gasification burner design and fuel handling to make and operate the fuel delivery and burner system described. It is important to note that the present invention is not limited to satisfying one or more of the above features or advantages of the invention. It is also important to note that present invention is being described to enable one skill in the art to make and use the invention. As such, modifications and substitutions by one of ordinary skill in the art are considered to be within the scope of the present invention, which is not to be limited except by the following claims.

Some variation in construction is allowed to still achieve the same result. For example, a variety of different igniter configurations are possible and they could be oil or gas fueled. But generally, a blowtorch type spark ignition igniter would be used. Also, a given gasifier can have several burners of varying sizes to meet the required load. For example a 400 MW IGCC power system would typically have ten or more burners pointed downward in the gasifier entrained flow chamber 1 as described here. Or, burner nozzles may not need to utilize the Coanda effect to achieve adequate eddies or flame retention for complete combustion (gasification) at near theoretical air and steam rates needed for gasification at low temperatures (approximately 1650° F. area).

Adjustability and precise measurement and control of key variables enable more flexibility in the overall burner design while still achieving satisfactory performance. What follows is believed by the inventor to be the best way to practice the invention. But such practice is not limited to just the methods shown here, as noted above, while still remaining true to the innovative claims of this invention.

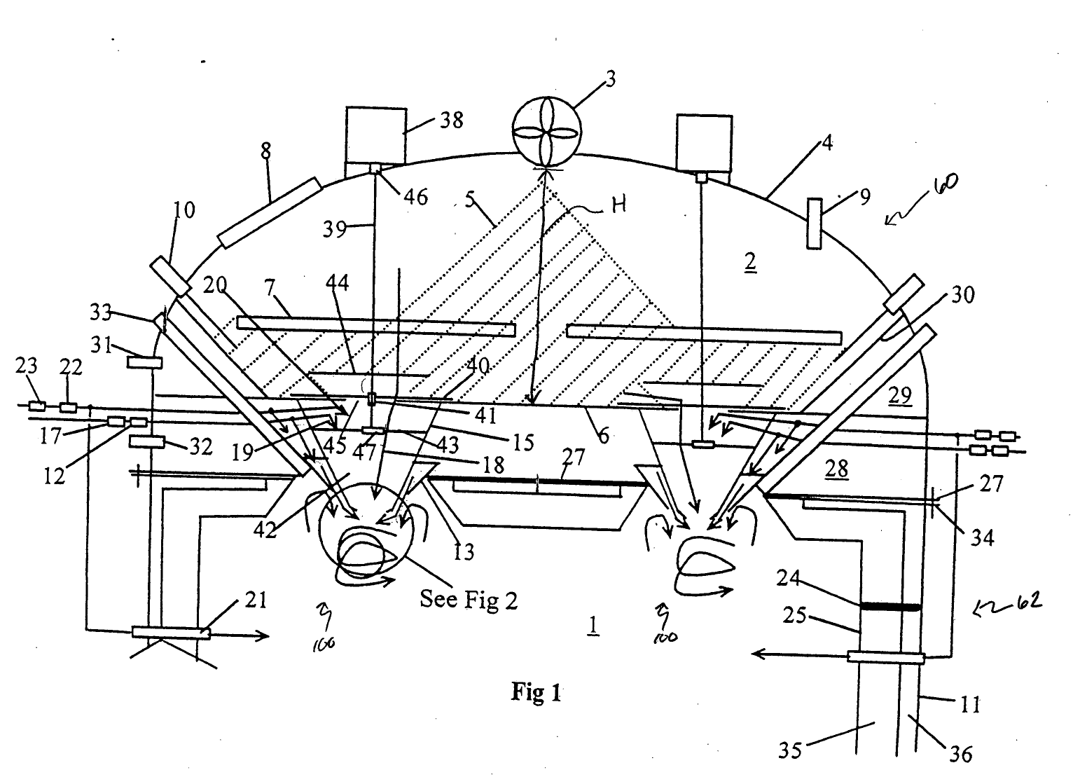

FIG. 1 shows two burners 100 in section. But they are identical in operation, so only one burner 100 is labeled and described herein. Individual coal burners 100 can reach up to 40 MW in size, and more. One objective of the present invention is to achieve this large burner 100 capability with PCPG gasifier burners 100 operating at near theoretical air/fuel ratios and when the airflow volume when pressurized is many times lower than atmospheric combustion. How many times lower this volume of combustion air is depends on the compression ratio above atmospheric pressure that the gasifier operates under, but 20:1 (300 psi) is an example of gas turbine compressor output pressures for industrial turbines.

At 50% overall gasifier IGCC power efficiency, one PCPG 40 MW burner 100 as envisioned as a standard size for this gasifier would require 273,000,000 Btu per hour fuel input. Coal fuel at 10,000 Btu/pound feeds about 27,300 pounds per hour (455 pounds per minute) or about 9.1 cubic feet pulverized coal per minute assuming 50 pounds per cubic foot pulverized coal density. At about 47 cubic feet standard air per pound fuel gasified (varies with Btu content of fuel and gasifier temperature of operation) and 20 to one compression ratio, the burner 100 supplies about 47×455/20 or 1069 actual (pressurized) cubic feet per minute of air, or about 119 times more air volume than fuel volume under pressurized gasification conditions. The pressure of this air and the pressure of the steam can be adjusted to insure good mixing (tornado effect) during initial combustion, hence thorough gasification.

Adjusting performance can favor one parameter over another and cause capacity to reduce over maximum design. However, all flows on this burner 100 are measured and are adjustable such as steam, air, and fuel feed so that optimization computer programs can measure and control all desired gas characteristics and maximize gasification reactions with minimal carbon loss in the ash. The gasifier is preferably operated at or near theoretical air/fuel ratio, or with slight excess air, which produces some CO₂ in the final gas, which is desirable for process control purposes since it is a gas easily measured with conventional on-line instruments. The burner 100 is designed to achieve adequate combustion, which in combination of the red-hot ash bed, to react char produced during gasification to minimize carbon losses in the ash. The CO/CO₂ ratio at theoretical air/fuel ratios, by volume, should exceed 20:1, with CO₂ less than 1%, but more CO₂ can be tolerated and still achieve acceptable operation. Simultaneously, for the above fuel, the steam rate should be about 0.4 pounds steam per pound fuel at the 1600 F temperature of gasification. Lower Btu fuels will require less air and steam and higher temperatures of operation will require less pounds steam per pound air. All the necessary parameters are being separately measured and controlled (air, steam and fuel flow rates, gasification temperature, gas CO₂ and CO content) in the present invention to control the gasification process to as near theoretical maximum gasification efficiency as possible. Thus, one aspect of the present invention focuses on an apparatus/method of fuel distribution and feed, burners, and measurements and controls in order to optimize the gasification reactions.

According to the preferred embodiment, burners 100 are disposed about a common center circle on the gasifier with burners being disposed in the center given adequate space. Entrained flow gasifier space 1 is where nearly all the gasification takes place from the incandescent (about 1600-1650° F.) burning (gasification) action of the pulverized coal. The top dome space 2 is reserved for pressurized (from the feed silos, not shown) fuel storage from feed screw conveyor(s) 3, which would converge at this dome apex position (connection details not shown). As many as three conveyors 3 can converge at the dome apex shown either feeding directly into the dome or into a lock hoppers above the dome which in turn feed into the dome top area. The fuel drop height H from the inside top of the steel dome 4 to the unloader and fuel support plate 6 is preferably large enough to allow fuel 5 to seek an angle of repose (generally as shown) so gravity flow of fuel 5 is adequate to all burner leveling bars 7, even if a bar 7 stops rotating for any reason. Plate 6 is welded to dome 4 and burner shells 15 and igniter tubes 33 are also welded to dome 4, plate 6, and plate 27. This enables the top dome fuel and burner assembly 60 to be removed as an assembly simplifying maintenance and leaving the lower gasifier refractory assembly 62 intact. Dome 4 preferably includes a large flanged maintenance person access portal 8 and is nitrogen purged when operating with valve 9. Fuel 5 has one or more level sensors 10 to control fuel feed by conveyor(s) 3. Three or four or more such sensors 10 may be used in parallel depending upon how many burners are installed. The gasifier pressurized cylindrical steel shell 11 of the gasifier and dome shell 4 must withstand the gasification pressure, such pressure vessel design well understood in the art. Cylindrical shell 11, plate 27, and refractory support plate 34 are preferably cooled (cooling details not shown), but the dome 4 would not need to be cooled. The lower ash bed reaction space described in the '815 patent application, and fully incorporated herein by reference, is not shown.

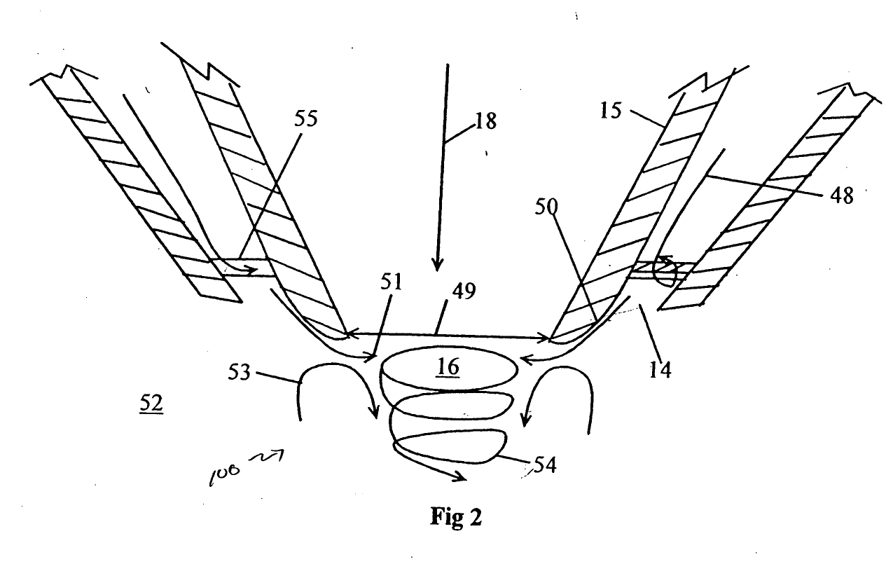

About a five-psi boost or more as needed in pressure over and above gasifier chamber 1 pressure is needed for air burner flow 48 (see FIG. 2) plus needed pressure drop for air control valve 12. The overall pressure loss through the gasifier system includes this burner losses, gas cooler losses, which are minor, gas filter losses (not shown) of about five-psi loss plus pipeline loses. All electric motor losses are minor, thus the overall losses through the pressurized gasifier system can be as low as fifteen psi or depending on how much pressure is required to achieve adequate fuel swirl or tornado effect from the burners. Or gasifier parasitic loss of less than 0.5% percent. This is much less parasitic loss than for O₂-blown gasifiers. To achieve the 1069 ACFM noted previously for a 40 MW burner 100 at 5 psi boost pressure, air gap 14 (see FIG. 2) at the burner 100, burner nozzle area would be set to about fourteen square inches area or a gap of about 0.5 inches for an nine inch outer burner barrel 15 at the ignition area 16 (see FIG. 2). Each burner plenum 13 would have an airflow measurements 17 and control valves 12 to modulate the burner air rate. Higher pressure drops to achieve adequate swirl would necessitate a smaller gap.

The fuel feed rate for one 40 MW burner operating at 50% power efficiency is about 27,000 pounds per hour of coal fuel or 9.1 cubic feet per minute at 50 pounds per cubic foot pulverized fuel density. This high fuel rate per burner is why a vertical burner configuration is preferred as gravity assists with downward fuel flow 18 through tapered burner barrel 15 with fuel discharging in the ignition area 16 through about an 8-inch final inside diameter 49 discharge area for burner barrel 15 (see FIG. 2).

Steam rate control for burner steam nozzle 20 and side steam nozzles 21 are controlled by valve 22, as shown in FIG. 1, with steam flow measurement 23 integrated with the main control computer (not shown). Typically, about 0.4 pounds of steam are required per pound of fuel, but this can vary with fuel moisture and ash content, for example, with less steam required at higher gasification temperatures. Gasifier temperature as measured by vertical multiple gauges 24 (only 1 shown) along the inner refractory wall 25 of gasifier measurements can be used to determine steam cooling flow requirements. Steam pressure obviously must be maintained substantially above the gasifier space 1 pressure to overcome space pressure and valve 22 and steam nozzle 21 loses; those skilled in the art can design such pressure systems. Steam burner nozzle 20 flow is sized to assist with fuel flow from the burners 100, but not so much steam through the burner nozzle 20 as to quell the ignition 16 or displace fuel flow 18 such that the gasifier could achieve adequate fuel flow 18 through burner cavity 42 to achieve maximum design load. Experts in the field can use computer simulations to optimize cavity exit diameter 49 with maximum load and needed air and steam flows from adjustable nozzles 19 and 20 respectively to help randomize and propel pulverized coal 18 out the burner nozzle diameter 49 (FIG. 2) so as to achieve best combustion practice. But these flows must be limited, as noted, so as not to displace needed fuel flow 18 with air and steam volume. While not shown, separate automatic valves to control air and steam flows from nozzles 19 and 20 could be provided.

Load capability is determined by fuel rate in conjunction with near the theoretical air/fuel ratio. This air/fuel rate is trimmed by the CO₂ and CO/CO₂ ratios as measured in the final gas (measurements not shown). Using 10,000-13,000 Btu per pound coal at 10% ash content, about forty-seven (47) total cubic feet of standard air per pound of fuel is needed. This can vary depending on fuel Btu content, ash, and moisture content and temperature of operation. With thorough burner combustion at near theoretical air/fuel ratios, final (standard conditions) of gas CO₂ measurement should fall to about 1%, and CO content should be above 20% by volume at for moderate red-burn temperature of about 1600-1650° F. Thus, CO₂ of about 1% and CO/CO₂ ratios of about 20:1 can be used to control the air/fuel ratio near theoretical using air valve 12 and fuel feed as determined by speed of gear head motor 38. Also, at any given air/fuel ratio, less steam is required for a higher gasification temperature, but steam rate in any event is controlled as measured by temperature sensors 24. Also, exceeding the theoretical air/fuel ratio will increase burn temperature, which will require more steam to maintain the same temperature, but it will also reduce gasification efficiency and is to be avoided as much as possible. The computer control algorithms must take this into account consistent with desired combustion efficiency. Up to 6% CO₂ in the final gas at standard conditions can be acceptable. The control computer, not shown, can incorporate an intelligent program such that the above measurements and operations are adaptive for maximized gas making efficiency with only minimal starting parameters inserted into the computer and depending on initial fuel characteristics. It is desired to operate the gasifier hot enough to achieve low carbon losses (about 0.5% by weight on a fuel basis) and hot gas efficiencies above 95%. A well-insulated system and gasification temperature at about 1600-1650° F. in part achieves such gas efficiencies. Wet fuels may require some drying to achieve maximally efficient gasifier operations.

In FIG. 1, the fuel distribution and burners are housed between upper bell 4 and flanged plate 27. There are three primary cavities above plate 27, fuel replenishing and distribution and feed space 2, burner shell or barrel space 28, and space 29 created by inclined conical partition 30, all individually nitrogen purged, as needed by vales 9, 32, and 31 respectively. Burner air plenums 13 and igniter 33 are typically welded in openings of plate 6 which is flanged to refractory supporting plate 34, which also has cut openings adequate to accommodate burner air plenum 13 and igniter 33.

The fuel system from alternatively filled silos (not shown here but described in the original PCPG invention) and feed screw conveyors 3 are pressurized to greater than gasifier operating pressure and also nitrogen purged as needed. High temperature insulation 36 is installed between high temperature refractory 35 and gasifier circular shell 11 which would be installed in the usual manner. This typical construction of combustion vessels of this type where it is desired to retain the heat to drive the gasification reactions. When the upper dome 4 and flange plate 27 are removed, burner shells and igniters and fuel, unloaders and unloader drives are removed as a unit away from holes in refractory support plate 34.

In the present invention, the burners 100 are preferably designed with individual controlled feeders for more precise fuel distribution, which can be controlled by the speed of feeder variable drive gear head motor 38. The gear head drive 38 serves two functions. First, to level the fuel fed by fill screw conveyor 3 by leveling bars 7 attached to vertical drive shaft 39 (conveyors 3 would be feeding directly from the pressurized silos described in the '815 patent application, except in this instance, only the silo unloader would be needed as fuel distribution and metering is done as part of the this burner operations), and to control the feed rate of fuel 18 to the burner ignition zone 16. The feeder for each burner 100 is preferably comprised of helical unload/feed unloader plate 40 resting on plate 6 driven by 38 though flexible spline 41 on shaft 39, though other designs are also envisioned. Unloader/feeder plate 40 has multiple helical arms (not shown) reaching into the fuel 18 as necessary to meet maximum load conditions. Within the fuel mass 5 supporting by plate 6 is a flat rotating circular hood 44 attached to drive shaft 39, which prevents free fall of fuel 5 through fuel feed circular opening 45 in plate 6. Unloader helix plates 40 and the area under plate 40 on plate 6 could have removable (even if welded) hardened wear surfaces installed on plate 6 (not shown), as would be common practice in such high installations. Drive shaft 39 has suitable pressure seal 46 through dome 4 to gear head motor 38. This is the typical feeder design described in the '815 patent application. Fuel feeders to burners 100 could also be vertical screw conveyor devices or even vibratory feeders as long as repeatability in feed rate and control is achievable.

As shown, burner shell 15 is tapered as needed to achieve the final nozzle diameter 49 (FIG. 2). Shaft 39 also has a supporting ceramic bearing 47 on its lower end inside the tapered burner shell 15 which has a strut 43 attached to shell 15 inner wall to support shaft 39 end ceramic bearing 47. Portions of steam and or airflows 23 and 17 respectively prevent fuel material accumulating on this strut 43 or bearing 47. Depending upon how many burners are installed (two are shown here), the length of leveling bars 7 can be determined to insure adequate fuel mass 5. These bars 7 in effect determine the amount of fuel mass 5 and fuel addition rate by feed conveyors 3 to maintain level as determined by the sensor(s) 10. Unloaded fuel 18 falls by gravity through burner cavity 42 assisted by a portion of controlled steam and airflow 23 and 17 through nozzle 20 and 19 respectively. These flows facilitate fuel flow to the burner nozzle 49, but shall not be so large as to displace needed fuel volume 18 to each full load conditions as noted previously. The speed of gear head motor 38 can be calibrated to fuel mass flow rate which enables the control computer, not shown, to calculate an accurate air to fuel ratio based on fuel feed motor speed and air flow measurement 17 inputs to the computer.

Blowtorch igniter 33 shoots a long ignition flame (not shown) as needed to ignite coal in zone 16. Igniter 33 has a separate compressed air source and pressurized fuel source of gas or liquid and a nitrogen gas air purge, roof of combustion sensor and spark plug ignition, all not shown, but these are necessary components to such igniters to those skilled in the art. There are several suppliers of pulverized coal igniters with ignition flames as long as 60 inches. These igniters would have to be customized manufactured for pressurized operation for the burner of this invention and may need a permanent nitrogen purge after ignition is established to prevent fouling of the igniter end exposed to gasification combustion products.

FIG. 2 illustrates in detail the Coanda effect of increasing eddy-inducing effects at the burner ignition zone 16 to extend exposure of fuel/air mixtures to high temperature combustion conditions. This is done mainly by using the usual flame retention burner design of rapidly counter clockwise swirling air and steam 48 imparting swirl to fuel 18 and in part by utilizing the Coanda effect. With the Coanda effect, swirling air and steam flow 48 emerging from air nozzle 14 follows a curved surface 50. If the curvature 50 is not too sharp, it directs some of spiraling flow 48 into the fire zone 54 as flow 51 creating additional eddies to help lengthen the duration that coal is in the high temperature region. Simultaneously, curved steam and airflow 51, assisted in part by exposed burner nose 50 air curved flow 51 to combustion products 52, induces hot combustion products 52 to circulate into the ignition area and hot flame zone 54 creating additional eddies 53, which also assist with prolonged exposure of fuel to fire zone 54. Air/steam nozzle 14 of burner shell 15 has usual flame retention vanes 55 (those skilled in burner art can shape and determine the number of vanes 55 needed) within the nozzle gap to impart the vigorous counterclockwise tornado flame retention swirling motion 48. Thus, the combined actions of Coanda effect traverse swirl 51 through the flame 54 and induced circulation eddy 53 of combustion gases 52, all powered by the usual flame retention air nozzle swirl 48 maximally prolongs high temperature exposure of coal to the hot flame with minimal energy expended. Burner computer modeling by those skilled in the art can refine this arrangement prior to actual construction and test.

As stated above, the present invention is not limited to satisfying one or more of the above features or advantages of the invention. Modifications and substitutions by one of ordinary skill in the art are considered to be within the scope of the present invention, which is not to be limited except by the following claims.

The invention claimed is:

1. A burner system comprising:
a gasifier chamber;
a fuel chamber disposed above said gasifier adapted to contain a quantity of substantially dry pulverized coal at a pressure greater than an operating pressure of said gasifier chamber; and
at least one burner disposed about a top region of said gasifier chamber, said burner adapted to flow said substantially dry pulverized coal.

2. The burner system as claimed in claim 1 wherein said at least one burner includes:
a first passageway adapted to flow said substantially dry pulverized coal from said fuel chamber into said gasifier chamber; and
at least a second passageway adapted to flow a quantity of pressurized air and steam into said gasifier chamber.

3. The burner system as claimed in claim 2 wherein said second passageway is sized and shaped to promote a substantially helical airflow pattern as said pressurized air enters said gasifier chamber.

4. The burner system as claimed in claim 2 wherein said pressurized air and steam exiting said second passageway is substantially adjacent to and substantially encompasses said first passageway.

5. The burner system as claimed in claim 4 wherein an exit of said first passageway is sized and shaped to create a Coanda effect proximate said exit of said burner.

6. The burner system as claimed in claim 1 wherein said at least one burner includes:
a first cavity adapted to flow a pressurized air and steam into said gasifier chamber; and
at least a second cavity disposed substantially within said first cavity, said second cavity adapted to flow said substantially dry pulverized coal from said fuel chamber into said gasifier chamber.

7. The burner system as claimed in claim 6 wherein an exit portion of said second cavity is sized and shaped to create a Coanda effect proximate an exit portion of said burner.

8. The burner system as claimed in claim 6 wherein said first cavity is sized and shaped to promote a substantially helical air and steam flow pattern.

9. The burner system as claimed in claim 8 wherein steam and pressurized air is introduced into said second cavity proximate said exit portion of said second cavity.

10. The burner system as claimed in claim 1 wherein said fuel chamber includes said at least one burner, wherein said fuel chamber is removably secured to said gasifier chamber.

11. The burner system as claimed in claim 1 wherein said fuel chamber is pressurized.

12. The burner system as claimed in claim 11 wherein said burner system includes a plurality of burners and said fuel chamber further includes a fuel distribution device regulating an amount of substantially dry pulverized coal to each of said plurality of burners independently of other burners, said fuel distribution device including a plurality of feeders in communication with a motor, wherein at least one feeder is disposed proximate each of said plurality of burners.

13. The burner system as claimed in claim 12 wherein said feeder includes a generally helical conveyer.

14. The burner system as claimed in claim 13 wherein said generally helical conveyer includes a plurality of helical arms.

15. The burner system as claimed in claim 12 wherein said fuel distribution device further includes a leveling bar disposed within said fuel chamber above said generally helical conveyer.

16. The burner system as claimed in claim 15 wherein said leveling bar is in communication with said motor.

17. The burner system as claimed in claim 12 wherein said fuel distribution device further includes a hood disposed above and proximate said generally helical conveyer, said hood preventing said substantially dry pulverized coal from free falling through said feeder.

18. A method of increasing burn dwell time within a gasifier comprising the acts of:
injecting pulverized coal into a gasifier chamber proximate a top region of said gasifier chamber;
injecting steam into said gasifier chamber;
injecting oxygen into said gasifier chamber proximate said top region of said gasifier chamber;
mixing said pulverized coal, oxygen and steam within said gasifier; and
gasifying said mixture within said gasifier to generate a gas and bi-products.

19. The method as claimed in claim 18 wherein said act of injecting oxygen into said gasifier includes injecting pressurized air into said gasifier.

20. The method as claimed in claim 19 wherein said acts of injecting said pressurized air and steam includes generating a Coanda effect within said gasifier chamber.

21. The method as claimed in claim 19 wherein said pulverized coal includes substantially dry pulverized coal.

22. The method as claimed in claim 21 wherein said act of injecting steam into said gasifier chamber further includes combining steam with said substantially dry pulverized coal immediately prior to injecting said substantially dry pulverized coal into said gasifier chamber and injecting steam directly into said gasifier chamber.

23. The method as claimed in claim 19 wherein said act of injecting pressurized air into said gasifier chamber further includes combining pressurized air with said substantially dry pulverized coal immediately prior to injecting said substantially dry pulverized coal into said gasifier chamber and injecting pressurized air directly into said gasifier chamber proximate said substantially dry pulverized coal such that a substantially helical air and steam flow pattern is created as said pressurized air enters said gasifier chamber.

24. The method as claimed in claim 23 wherein said act of injecting pressurized air directly into said gasifier chamber further includes generating a Coanda effect within said gasifier chamber.

25. The method as claimed in claim 18 further including the acts of:
distributing said pulverized coal to a plurality of burners; and
metering an amount of pulverized coal distributed to each of said plurality of burners independent of other burners.

26. An apparatus for gasifying pulverized coal comprising:
means for holding a quantity of substantially dry pulverized coal above a gasifier chamber at a pressure greater than an operating pressure of said gasifier chamber;
means for injecting substantially dry pulverized coal into a gasifier chamber proximate a top region of said gasifier chamber;
means for injecting steam into said gasifier chamber;
means for injecting pressurized air into said gasifier chamber; and
means for generating a Coanda effect within said gasifier chamber.
